(19) United States
(12) Patent Application Publication
(10) Pub. No.: US 2019/0026836 A1
(43) Pub. Date: Jan. 24, 2019

(54) EXTENSIBLE INTELLIGENT FINANCIAL STRENGTH GUIDANCE SERVICE

(71) Applicant: brightpeak financial, Minneapolis, MN (US)

(72) Inventors: Mike MILKOVICH, Minneapolis, MN (US); Sami PELTON, Minneapolis, MN (US); Ahti HUJANEN, Minneapolis, MN (US)

(21) Appl. No.: 16/040,336

(22) Filed: Jul. 19, 2018

Related U.S. Application Data
(60) Provisional application No. 62/534,559, filed on Jul. 19, 2017.

(51) Int. Cl. G06Q 40/08; G06F 9/451; G09B 5/02

(52) U.S. Cl. CPC G06Q 40/08; G09B 5/02; G06F 9/453

(57) ABSTRACT

A financial strength system is disclosed. The financial strength system can be extensible and customized to a user. In some aspects, the financial strength system obtains the results of a user-assessment from a user and a family member of the user, the results including data representative of practical, spiritual, cultural, emotional and behavioral relationship behaviors relating to money. Based on the results from both the user and the family member and a plurality of rules applied to the results, the system recommends a learning tool that will assist in improving one or more of the user's practical, spiritual, cultural, emotional and behavioral relationship with money. The system iterates, using a learning model, to successively recommend additional actions that can be taken by the user.

### CROSS-REFERENCE TO RELATED APPLICATIONS

The present application claims priority from U.S. Provisional Patent Application No. 62/534,559, filed on Jul. 19, 2017, the disclosure of which is hereby incorporated by reference in its entirety.

### BACKGROUND

Money is one of the biggest causes of stress and problems in a relationship. However, the problems related to money are not strictly reflective of the lack or abundance of money within the relationship. Rather, money problems are also reflective of the relationship itself, the backgrounds of the individuals in the relationship as well as the habits and skills of the individuals in the relationship. Unfortunately, most financial tools fail to consider anything beyond the amount of money present when making recommendations for building financial strength. This is an oversight that can have a significant and lasting impact on individuals, their relationships, and their money. It can also have a negative effect on user motivations to use the tools. Still further, if the financial tool appears to be providing the same advice over time, or providing advice to a generic user rather than personalized to the user, user incentives to utilize the financial tool are decreased.

### SUMMARY

In general terms, the present disclosure is directed to a platform service and, more specifically, to a financial strength platform service. The platform service can be, in various embodiments, an extensible, learning platform useable to provide advice to users regarding financial strength based on assessments taken by the user, and the user's similarity to other users of the service. By learning about the user (and optionally similar users), and by taking into account interactions between the user and those individuals or external factors that influence behavior, improved feedback to the user can be provided.

Furthermore, because in some embodiments the platform service is reconfigurable for different user groups and extensible over time to include additional user assessments and service additions, the platform service is able to continue to improve and change the ways it interacts with users, thereby further improving user experience.

In a first example aspect, a platform service is configured to obtain the results of a user-assessment from a user and a family member of the user, the results including data representative of practical, spiritual, cultural, emotional and behavioral relationship behaviors relating to money, and based on the results from both the user and the family member, recommend a goal that will assist in improving one or more of the user's practical, spiritual, cultural, emotional and behavioral relationship with money.

In a second aspect, a system includes a computing platform accessible by a plurality of users via client systems communicatively connected thereto, the computing platform hosting a financial strength guidance application. The financial strength guidance application includes at least one user segment layer constructed for use by a category of users; a recommendation engine layer configured to iteratively generate recommendations for actions to be taken by a user, the recommendations displayable in the user segment layer; and an extensible capability hosting layer comprising a plurality of user engagement tools, each of the plurality of user engagement tools exposing an Application Programming Interface (API) to the recommendation engine layer, the plurality of user engagement tools including at least a financial recommendation tool, a challenges tool, an incentives tool, a dashboard tool, and a community tool. The recommendation engine layer is configured to, based on a determined assessment of a user interacting with the system via the at least one user segment layer, call one or more of the user engagement tools via a corresponding API to engage the user with the one or more user engagement tools.

In a third aspect, a computer-implemented method of interacting with a user to provide a financial strength guidance is provided. The method includes obtaining, at a financial strength service, the results of a user-assessment from a user and a family member of the user, the results including data representative of practical, spiritual, cultural, emotional and behavioral relationship behaviors relating to money. The method further includes, based on the results from both the user and the family member and a plurality of rules applied to the results, iteratively recommending one or more learning tools that will assist in improving one or more of the user's practical, spiritual, cultural, emotional and behavioral relationship with money. The method also includes, in response to selection of a learning tool, calling one or more of a plurality of user engagement tools, each of the plurality of user engagement tools exposing an Application Programming Interface (API) via which the corresponding user engagement tool is extensibly integrated into the financial strength service.

### BRIEF DESCRIPTION OF THE DRAWINGS

FIG. 1 illustrates an example platform in which a financial strength service of the present disclosure can be implemented.

FIG. 2 is an example schematic diagram of the modules that comprise the financial strength service.

FIG. 3 is an example logical schematic of an extensible architecture for the financial strength service of FIG. 2.

FIG. 4 is an example user experience layer useable within the extensible architecture of FIG. 3.

FIG. 5 is an example platform recommendation engine useable within the extensible architecture of FIG. 3.

FIG. 6 is an example extensible engagement capability layer useable within the extensible architecture of FIG. 3.

FIG. 7 is an illustrative data flow through the financial strength service described herein.

FIG. 8 is an example of a simplified flowchart of data processing within the financial strength service of FIGS. 2-7.

FIG. 9 is an example of a simplified flowchart illustrating the various functions and/or operations performed by the financial strength service.

FIGS. 10A-10B are examples of user displays welcoming a user and requesting assessment of the user for use in a financial strength service.

FIG. 11 is an example of user display that illustrates an overview of the results of an initial assessment performed in accordance with the financial strength service.

FIG. 12 is an example of a user display that illustrates detailed results of the initial assessment performed in accordance with the financial strength service.

FIGS. 13A and 13B are examples of user displays that illustrate first and second learning tools, respectively, for a specific chapter defined by the financial strength service.

FIG. 14 is an example of a user display illustrating the offer of products or services through the Transact learning tool of the financial strength service.

FIG. 15 is a schematic of an example computing device with which aspects of the present disclosure can be implemented.

### DETAILED DESCRIPTION

As briefly described above, embodiments of the present invention are directed to a financial strength service executed on one or more computing devices. The financial strength service is accessible to a plurality of users through any number of wired or wireless pathways. In making recommendations to work towards financial strength, the financial strength service considers a plurality of dimensions (e.g., practical, spiritual, cultural, emotional and behavioral) that affect love and money. These plurality of dimensions are reflected in an initial assessment of a user to learn about their love and money history. Based on the assessment, the plurality of dimensions are again reflected in the financial strength chapters that are recommended to the user by the financial strength service; one or more learning tools directed to areas of focus within the financial strength chapter are also recommended. In certain examples, the financial strength service makes recommendations of chapters and learning tools based on the initial assessment of two users that are in a committed relationship and share finances, as opposed to an individual user.

As noted above, the plurality of dimensions of love and money considered within the financial strength service include practical, spiritual, cultural, emotional and behavioral dimensions. The practical dimension addresses the rational or logical side of money, such as what we have, how much we have, savings, debts and accounts. The spiritual dimension takes into account that how we relate to money is a reflection of our most deeply held beliefs and values. The spiritual dimension is about meaning and purpose including our connection to others, to God and to a bigger story. The cultural dimension pays respect to our families as well as racial, ethnic, regional, and socio-economic communities and circumstances that shape our lives, beliefs and values we hold today. The emotional dimension considers feelings and mental reactions to money, e.g. we “feel” money more than we “think” money. The behavioral dimension reflects our habits and actions, e.g. if and how we use a budget, how we communicate, how we use our accounts, how we spend, how we save and how we give.

In addition, the present disclosure describes an extensible platform service capable of uniquely assessing users based on platform services that can be added or enabled over time, as well as user interface layers designed for interaction with specific user groups. The extensible platform service improves platform flexibility to selectively add various components to the service overall, or for particular users or user groups specifically. As such, rather than a uniform financial assistance and strength assessment service that can be provided to a user, the present application presents customized user interfaces generated based on user assessments that allow for improved outcomes due to increased user engagement. Furthermore, the extensibility described herein allows for continued improvements to the financial strength service over time and allows inclusion of new assessments, thereby maintaining accuracy and user interest over time. Other advantages are apparent as well from the following disclosure.

### I. Platform

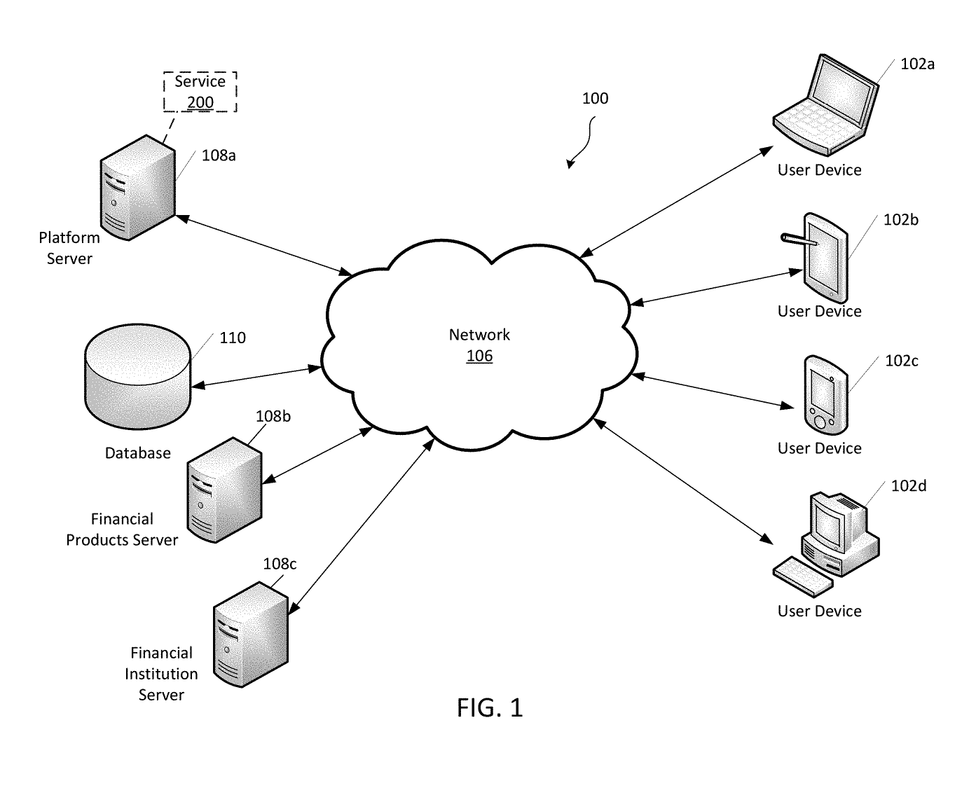

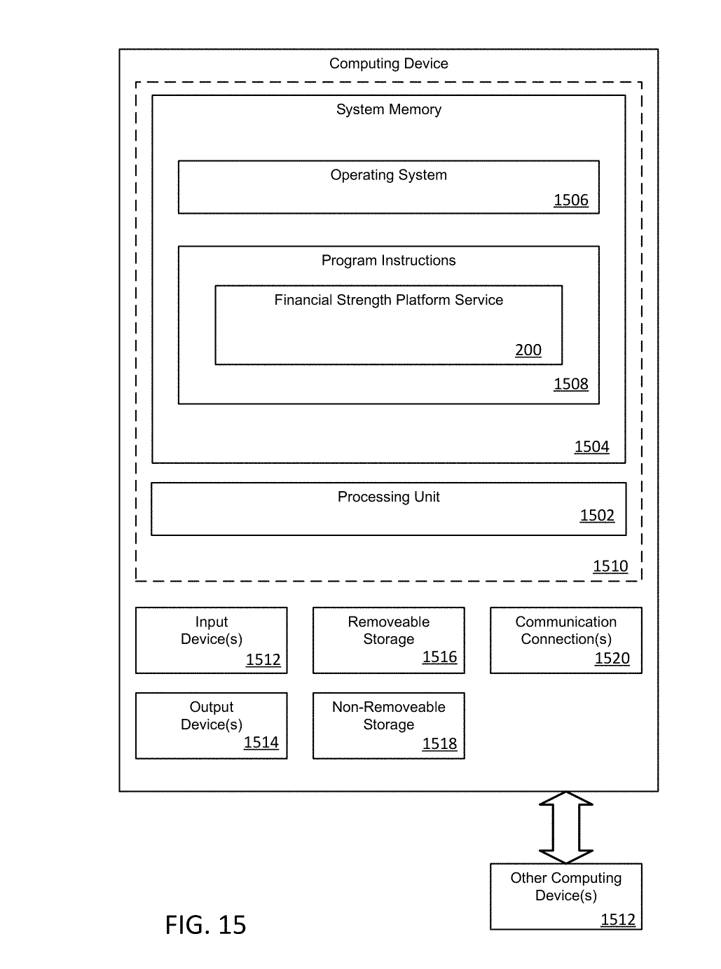

FIG. 1 illustrates an example platform 100 to institute financial strength services for various user types including single individuals and couples (married or unmarried but committed) that share finances. The example platform 100 can include various user-interactive devices, e.g., a laptop 102a, a table 102b, a smart phone 102c, a desktop 102d or any other type of user-interactive computing device that is configured to process digital instructions. The devices 102a-102d communicate via wired, or wireless communication through network 106, to one or more servers of the platform 100. The servers can include for example a platform server 108a, which can host alone or in combination with the other servers the financial strength service 200, a financial products server 108b that offers various financial (or non-financial) products to be sold within the financial strength service 200, and/or a financial institution server 108c that provides banking-related functions used within the financial strength service 200. The one or more servers are configured to process digital instructions including instructions that when executed comprise the financial strength services 200 of the present disclosure. The platform 100 can further include one or more databases 110 for storage and retrieval of pertinent data. Further details regarding a computing device (e.g., the user-interactive devices or servers) are discussed below with reference to FIG. 15.

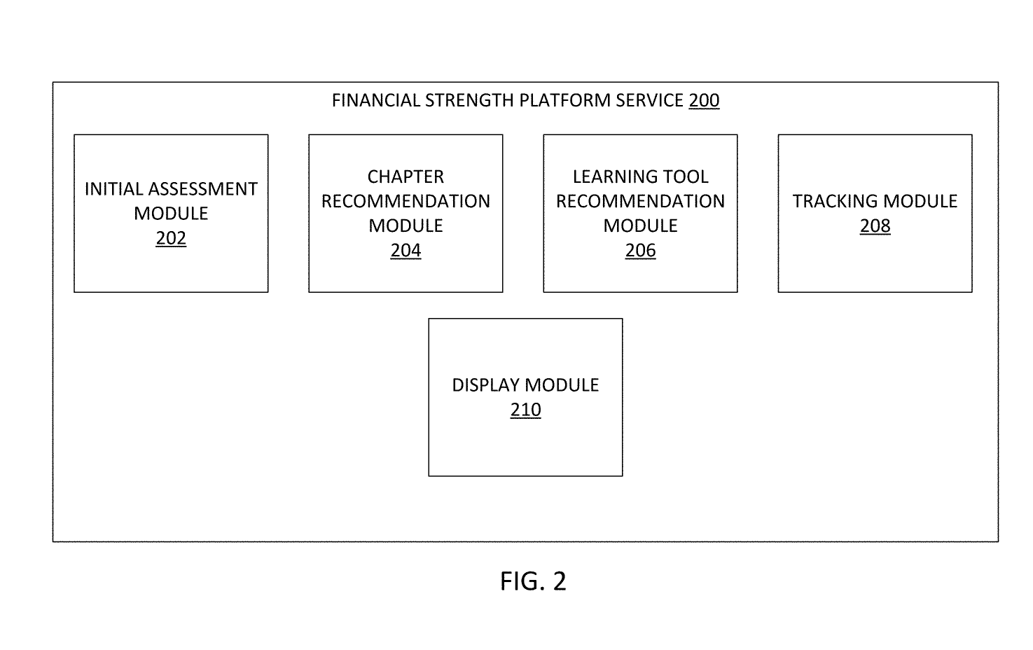

Referring to FIG. 2, the financial strength service 200 includes an initial assessment module 202, a chapter recommendation module 204, a learning tool recommendation module 206, a tracking module 208, and a display module 210. Each of the modules 202, 204, 206, 208, 210 generally comprises one or more program modules that include a collection of data, routines, objects, calls, and other instructions that when executed cause the performance of one or more particular tasks. It should be noted that, although certain program modules are disclosed herein, the various instructions and tasks described for each module can, in various embodiments, be performed by a single program module, a different combination of program modules, modules other than those described herein, or modules executed by remote devices that interface with the platform 100. Each of the modules 202, 204, 206, 208, 210 are described in further detail below.

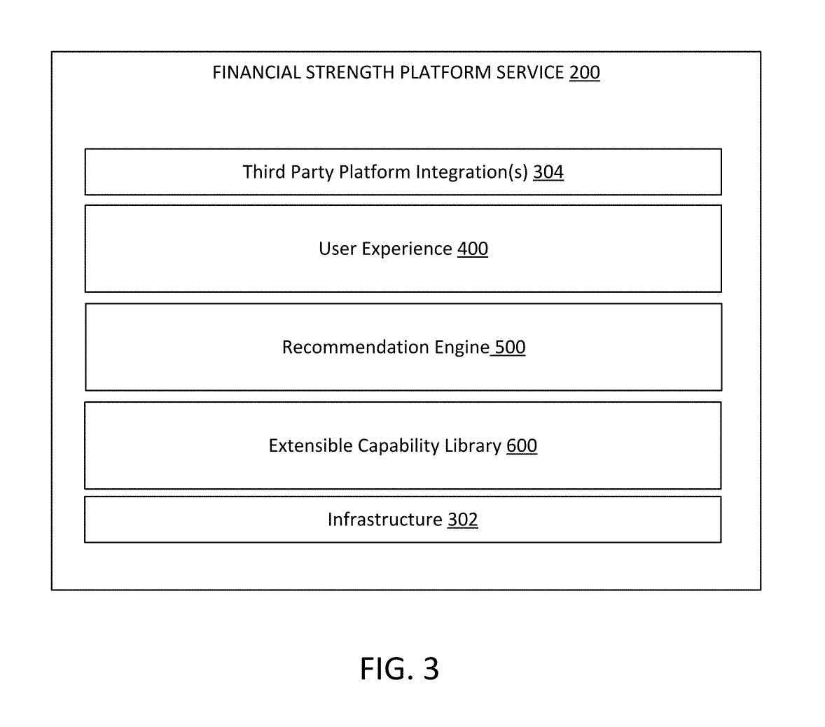

FIG. 3 is an example logical schematic of an extensible architecture for the financial strength service of FIG. 2. In the example shown, the financial strength service 200 is configured in a multi-layered, extensible and configurable architecture in which various layer features can be implemented in particular implementations or for particular users. In this manner, the assessment and recommendation modules can be implemented using one or more architecture layers, including generation of recommendations and/or calling of internal or external services from a library to provide learning and assessments to the user, as well as financial strength guidance in an extensible, iterative, and intelligent platform.

In the example shown, the financial strength service 200 includes an infrastructure layer 302 and a third party platform integrations layer 304, separated by a user experience layer 400, a recommendation engine, and an extensible capability library 600.

The infrastructure layer 302 corresponds generally to hardware and software services used to support and execute instructions or host data associated with the layers described herein, including the financial products, banking, recommendation and user interaction features described herein. Additionally the third party platform integrations 304 represent a highest-level layer, with which user interface components or data can be provided to or integrated into third party websites, e.g., for partnering programs among organizations that may wish to provide financial strength scoring and advice.

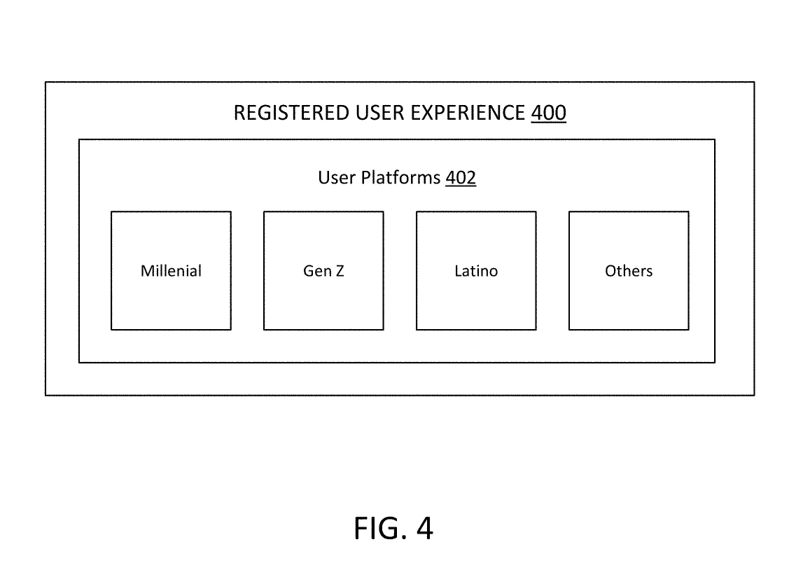

The user experience layer 400 presents a user experience to a particular user or user group. In example embodiments, the user experience layer 400 includes a plurality of user experience packages selectable by a service provider to be presented to users of the service; example user experience packages are described in greater detail below in connection with FIG. 4. Generally, the user experience layer 400 can associate a specific user experience package with specific capabilities accessed via the extensible capability library 600, and as assessed via the recommendation engine 500 to generate recommendations or further interactions with a user. Example user interfaces are illustrated and described below.

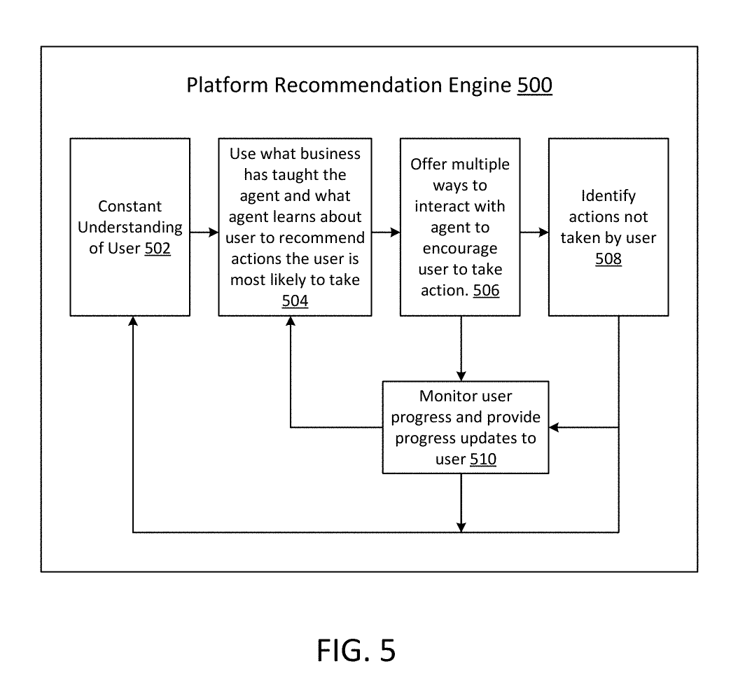

The recommendation engine 500 generally processes interactions with the user based on, for example, information obtained specifically from the user or information inferred about or gathered regarding the user from third party sources. The recommendation engine 500 can, in various embodiments, employ a data model regarding successful or unsuccessful outcomes to generate recommendations for action by a user, based on, for example the user's experience and attitudes regarding his/her financial service, reactions of family members to financial decisions, and various other factors for balancing financial strength in a manner that will be successful for that user. Details regarding an example implementation of the recommendation engine are provided below in connection with FIG. 5.

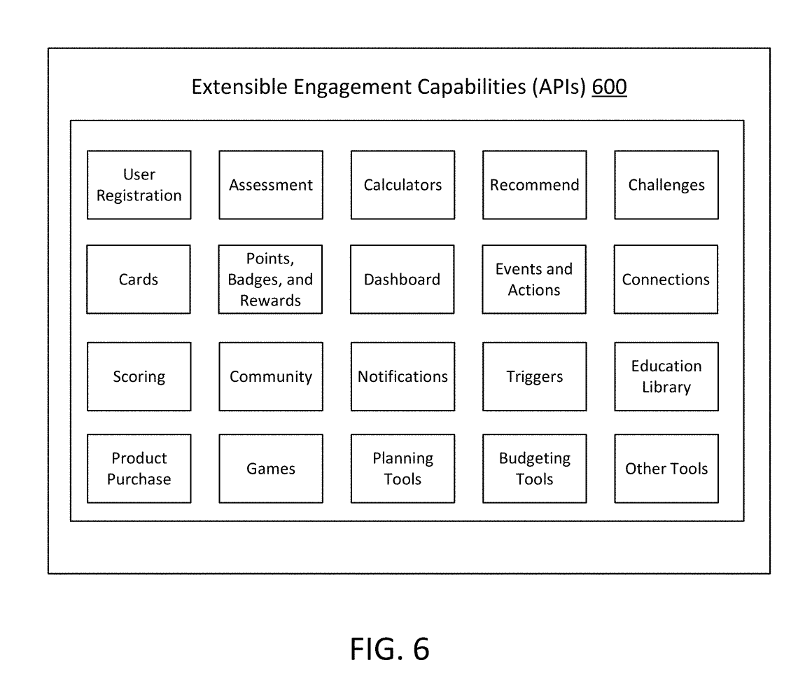

The extensible capability library 600 includes a plurality of capabilities packaged for selective access and use by a user experience layer 400 and which can provide data to the recommendation engine 500. In various embodiments, the extensible capability library 600 includes modules which each expose an Application Programming Interface (API) that can be called for various purposes; for example, different user assessments or assessment types can be incorporated, or additional recommendation processing can be provided (e.g., based on one or more extensible neural network or artificial intelligence models). Such additional recommendation processing can be provided as part of a call to an extensible capability module (e.g., an artificial intelligence module), e.g., during step 504 of FIG. 5, below. Additionally, modules providing education, social networking and working group support, incentive systems, calculators, or various budgeting tools could be used. A detailed illustration of an example extensible capability library is illustrated in FIG. 6.

It is noted that each of the layers described above may interact in various ways. For example, the recommendation engine 500 may recommend specific capabilities for a user to utilize that may better assist that user, where the specific capabilities are exposed or available through the extensible capability library. Additionally, certain extensible capabilities may be available through different user experience packages of the user experience layer 400, or may be exposed when integrated with specific third parties via the third party platform integrations 302.

As seen in FIG. 4, an example user experience layer 400 is useable within the extensible architecture of FIG. 3, and includes a plurality of user experience packages within user platforms 402. In the example shown, the user experience packages include a millennial user experience package, a “Gen Z” experience package, and a Latino experience package. Other experience packages (e.g., for families, individuals, other user groups) are possible as well. Each can have a particular user appearance (familiar feature layout, language, messaging, etc.) and can be targeted to specific user groups.

The example user platforms 402 describe the user based on various demographic considerations. In this example, the user experience packages include various factors such as, for example, the generation with which the user most likely identifies, the user's cultural or racial background, the user's religion, etc. In this example, the user demographics module obtains this demographic information from the initial user assessment as described above or from a financial agent directly. The user packages may also use information collected from other users who are similarly situated with the particular user. For example, such packages may analyze financial actions successfully taken by other users who share similar demographic information of the particular user when generating a financial plan for the user. As described herein, this demographic information may be used to further define a personalized financial plan for the user. In particular, the demographic information can be used to understand likely actions the user would take or would value when planning for a financial future.

The user experience packages also describe the overall flow that each registered user experiences using the financial strength service. This can include, for example, a sequence of steps that the user may encounter while using the financial strength service in order to receive personalized financial planning services. In this example, the service 200 collects information about the user to gain a better understanding of who the user is. This may be done through, for example, the initial user assessment or a conversation recorded between the user and one or more financial agents. The information collected may relate to the dimensions described above (e.g., practical, spiritual, cultural, emotional, and behavioral). The service 200 then provides one or more financial recommendations to the user. These financial recommendations may provide goals (e.g., chapters) for the user to focus on based on the dimensions as well as tools to use in order to achieve those goals, wherein the goals and tools are further part of the platform described above with reference to FIG. 1. Based on these recommendations, the recommendation engine 500 (of FIG. 5, below) may generate a recommendation to the user to commit to the financial plan and to take action. This may be accomplished via a coach provided through the platform that frequently checks in with the user. Alternatively or additionally, the service 200 may alter the plan based on actions taken by the user that do not coincide with the generated plan (e.g., based on calculation by the platform recommendation engine 400). Thus, the user's past behavior in combination with the user's demographic information can be used to generate and modify a plan with which the user would comply.

FIG. 5 is an example platform recommendation engine 500 useable within the extensible architecture of FIG. 3. The platform recommendation engine 500 processes interactions with a user to determine one or more actions to be taken or not taken by the user based on a variety of factors, including the user's stated goals/preferences, reactions by the user and other users managed by the system, and various analyses associated therewith.

In the embodiment shown, the platform recommendation engine performs a method including developing an understanding of the user (step 502), which can come from assessments performed by the user, reactions of other users associated with the user (e.g., family members), and externally accessible, third party data associated with the user (e.g., social networking or public records associated with the user). Based on the information about the user, a human agent or virtual agent can interact with the user to recommend one or more types of actions to take by the user (step 504). The actions may include, for example, taking an assessment, completing a profile, etc. The actions can be recommended to the user (step 506) and based on monitoring of the user, certain actions that the user does not take (step 508) and actions that the user does elect to take (step 510) are monitored. Based on the actions not taken, the recommendations to the user may be removed over time, for example to be replaced with other suggestions that are more likely to be of interest to the user. Based on the actions taken, a user's progress toward financial goals are tracked and feedback is provided both to the user, to the system's understanding of the user, and as part of further recommendations to present to an agent for consideration for presentation to a user.

As noted previously, various actions or processes may be supported by an extensible engagement capability layer 600, one example of which is seen in FIG. 6. In that example, the extensible engagement capability layer 600 includes a plurality of modules stored in a library which each expose APIs for consumption/use by either the platform recommendation engine 500 or user experience layer 400. In the example shown, the extensible engagement capability layer 600 includes a user registration module, an assessment module, a calculator module, a recommendation module, a challenges module, a cards module, a rewards module, a dashboard module, an events module, a connections module, a scoring module, a community module, a notifications module, a triggers module, an education library module, a product purchase module, a games module, a planning tools module, a budgeting tools module, and various other tools modules. Although operations made available by each of these modules may vary, the user registration module can receive user registration information from each of a plurality of user experience packages provided in user platforms 402, while the assessment module, challenges module, scoring module notifications module, games module, and education module (among others) may be selectively presented to the user for assessment and advancement of the user's goals. Various other modules, such as the planning or budgeting tools modules or product purchase module, may be presented or accessible to a user depending on the user's assessment, for purposes of financial planning and plan execution.

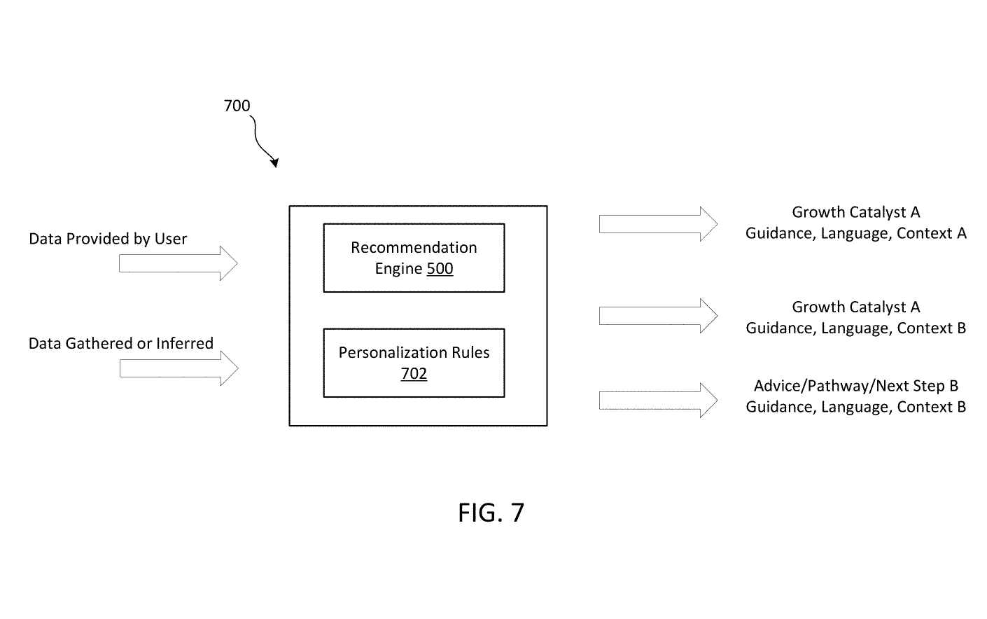

As seen in FIG. 7, an illustrative data flow through the financial strength service 200 is depicted. In general the service 200 can receive data that is provided by the user (e.g., data received via a user platform 402 calling one or more API-based modules in the extensible engagement capability layer 600 described herein. Additionally, data gathered or inferred regarding the user can be gathered as well; this information can be gathered from public information sources or from observation of the user (e.g., based on viewing/monitoring of user activity within a corresponding financial service platform, viewing/monitoring of other public information of the user (e.g., social media, public records, etc.) or activity performed using a computing system having cookies installed which provide information to the service 200. Based on the gathered and received user information, the recommendation engine 500 can use one or more personalization rules 702 to derive various outputs and feedback to the user. The personalization rules can include determined effects of particular actions for the specific user, rather than for a generalized user segment. For example, the personalization rules 702 can include preferences of the user, the user's family, or specific circumstances (e.g., budget or life circumstances providing constraints on user action). For example, the recommendation engine 500, using personalization rules 702, can generate a growth catalyst and guidance for a user, using specific language and content that is likely to generate a response from the user. Alternatively, the same growth catalyst, guidance, and language may be chosen, but a different set of content may be selected based on personalization rules. Still further, an entirely different set of advice or next steps can be suggested to the user or system, using different content and selected language.

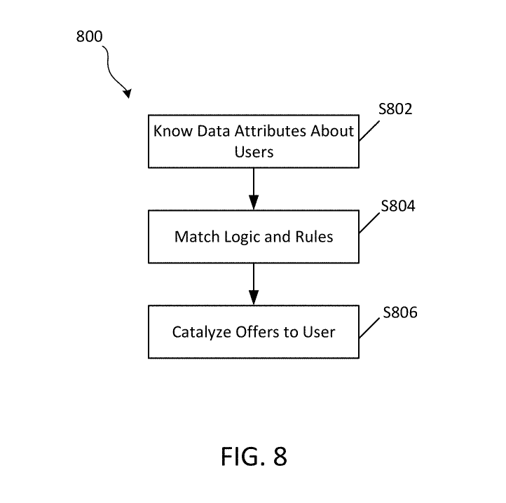

Accordingly, a generalized process of generating such recommendations for a user (which can be provided via a selected user platform) is illustrated in FIG. 8. In that example, a method 800 of data processing within the financial strength service 200 is shown. The method includes obtaining knowledge regarding data attributes about users of the financial strength service (step 802). The method further includes performing a matching of logic and rules (step 804) to determine actions to be taken using the financial strength service. Finally, the offers can be catalyzed and presented to the user, so the user may selectively take action as they may deem appropriate (step 806).

In this way, user interactions with the financial strength service 200 can be used to iteratively improve the recommendations from that service and the manner of interaction, including by accounting for specific features that may be most useful to the user by selectively accessing extensible modules from a library of such modules in the extensible engagement capability layer 600 to ensure that a complete assessment of the user is provided and improved selection of possible interactions is presented to that user.

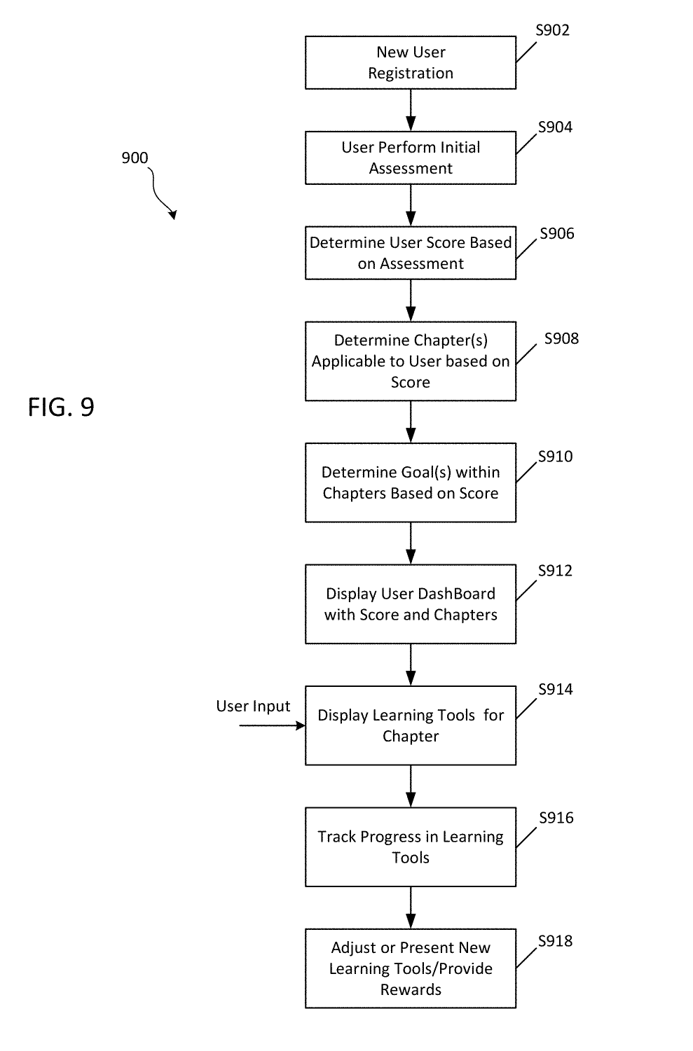

The flowchart of FIG. 9 illustrates a more detailed example of the operations that can be performed through execution of the various modules 202, 204, 206, 208, 210 of the financial strength service 200. As shown, operation of the financial strength service 200 generally begins with the registration of a new user, S902. Registering a new user can be performed according to any known registration system or method; e.g., simply establishing a username and password, or having the user present a digital certificate or key to the financial strength service 200. Upon registration, the user is provided with the opportunity to perform an initial assessment, S904, through use of the initial assessment module 202. Once the user has completed the initial assessment a user score based on the assessment is calculated by the initial assessment module 202, S906. The user score, which is stored by the tracking module 208, is then used by the chapter recommendation module 204 to recommend love and money chapters from which the user may benefit, S908; the recommended chapters are stored by the tracking module 208. Having determined the recommended chapters, the user score is then used by the learning tool recommendation module 206 to recommend learning tools from which the user may benefit, S910; the learning tools assist the user in focusing on a certain area of learning or understanding that is specific to the chapter. The recommended learning tools are stored by the tracking module 208.

It is noted that in various embodiments, the user score can include a plurality of different dimensions, with each dimension representing a different subcategory or attribute of the user which may tie to the user's overall satisfaction with his/her relationship with money. Example subcategories can include, for example, the user's risk tolerance, the user's sensitivity to his/her partner's expenditures, the user's saving or spending priorities, the user's emotional reactions to financial issues, or other types of behavioral categories which may affect either (1) learning tools that are recommended to the user, or (2) types of messages sent to the user as part of use of the platform, e.g., in the event of money-based notifications (e.g., alerts of spending of others).

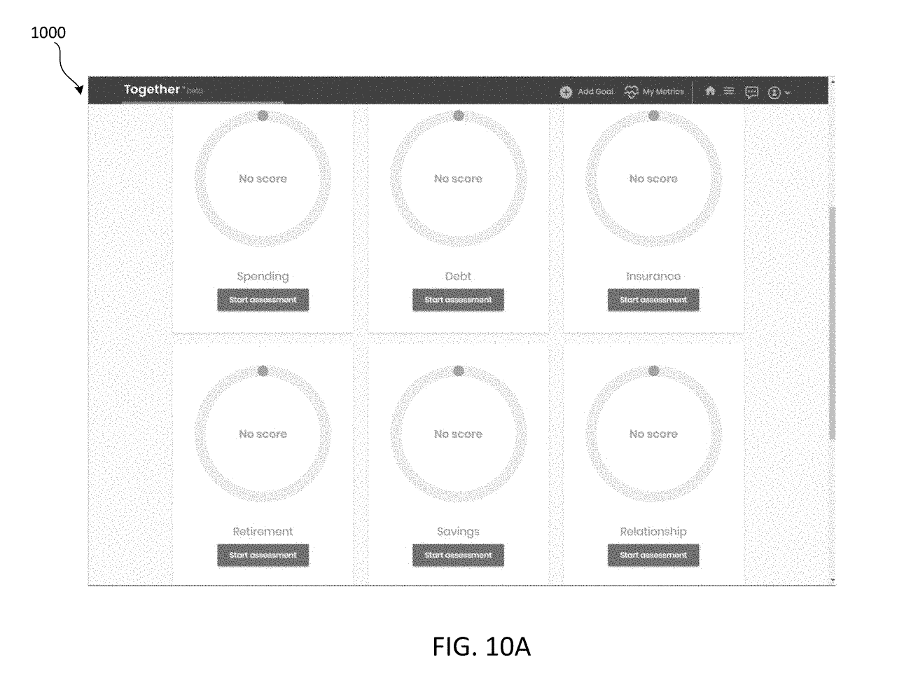

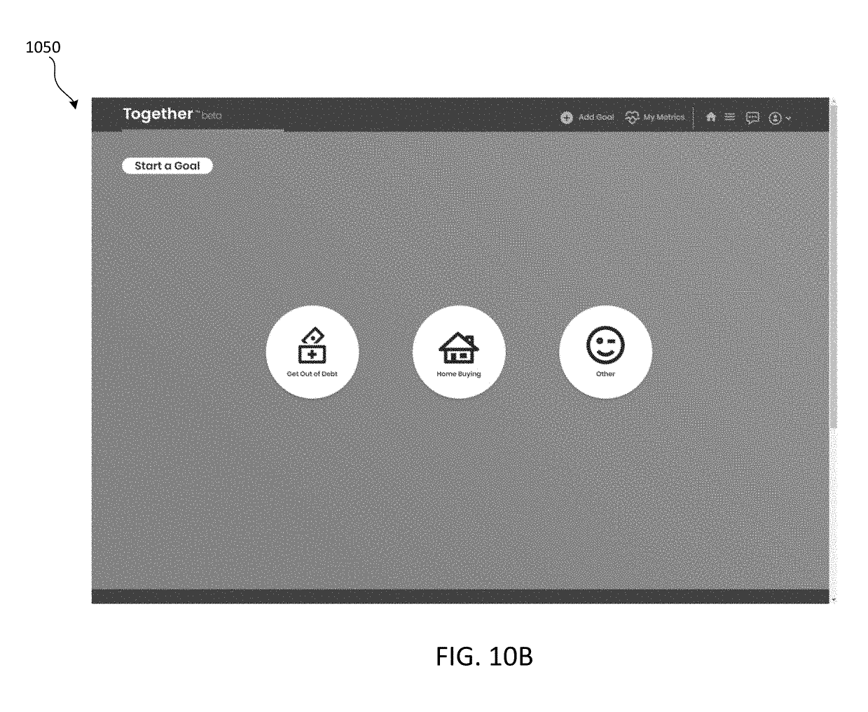

FIGS. 10A-10B are examples of user displays welcoming a user and requesting assessment of the user for use in a financial strength service. FIG. 10A illustrates a user interface 1000 showing a set of scores across a plurality of vectors of a user's experience, including the user's spending, debt, insurance, retirement, and savings, but also with respect to that user's relationship toward money, and how money affects the user's relationships. By accounting for this additional vector in the user's money relationships, unrealistic advice or requests are not generated or presented by the service 200, and improved relationship with money is sought in the same way improved savings, spending, debt, etc. positions are considered.

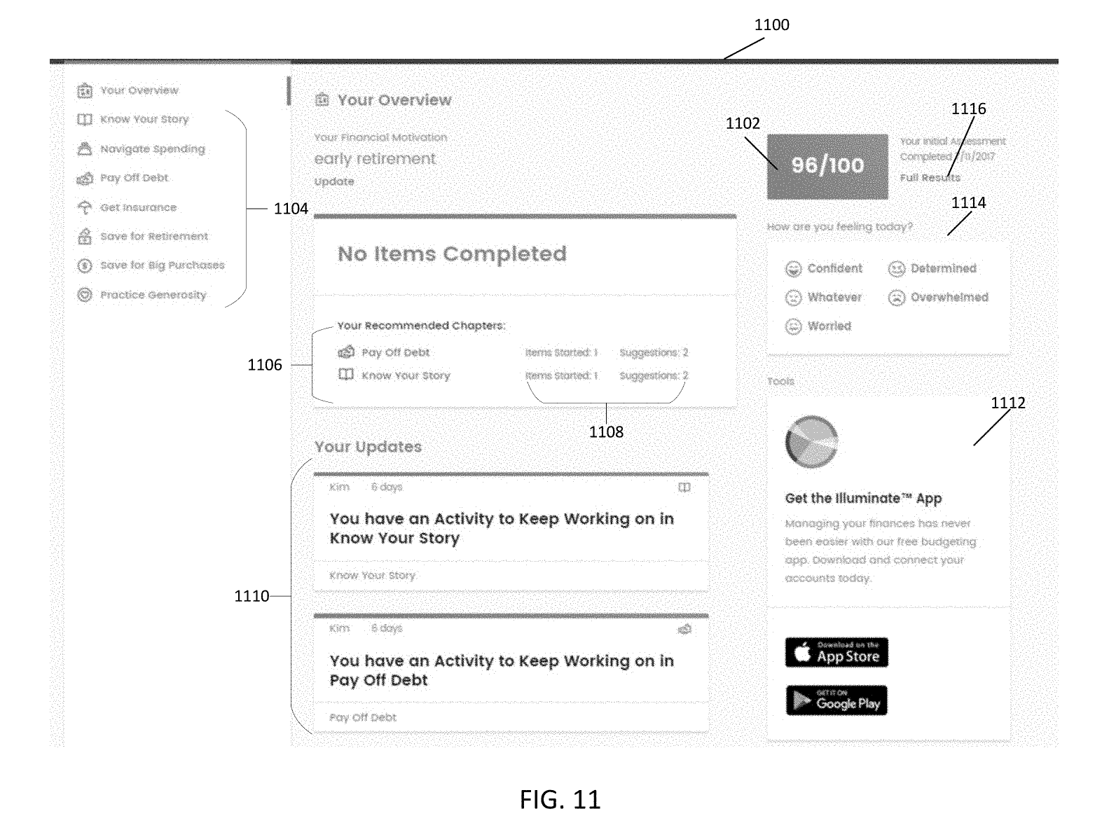

FIG. 10B illustrates an initial user interface 1050 that allows a user to set goals and initiate assessments, for example, to get out of debt, buy a home, or undertake some other type of goal. Upon completion of the initial assessment, the user is presented with a dashboard display that includes the user score as well as chapter recommendations, S912. An example of the dashboard display 1100 is illustrated in FIG. 11 and is shown as including a user score 1102, a complete chapter listing 1104, and a listing of recommended chapters 1106. The listing of recommended chapters 1106 further includes a listing of the number of recommended learning tools 1108 for each of the respective recommended chapters. The dashboard display 1100 additionally includes a status panel 1110 indicating which learning tools need to be completed and/or are completed, the offer of another learning tool 1112 that the user might wish to use, and a feeling board 1114 to indicate how the user is feeling on a certain day. A link 1116 to full results of the initial assessment is also provided. Other display configurations are also possible.

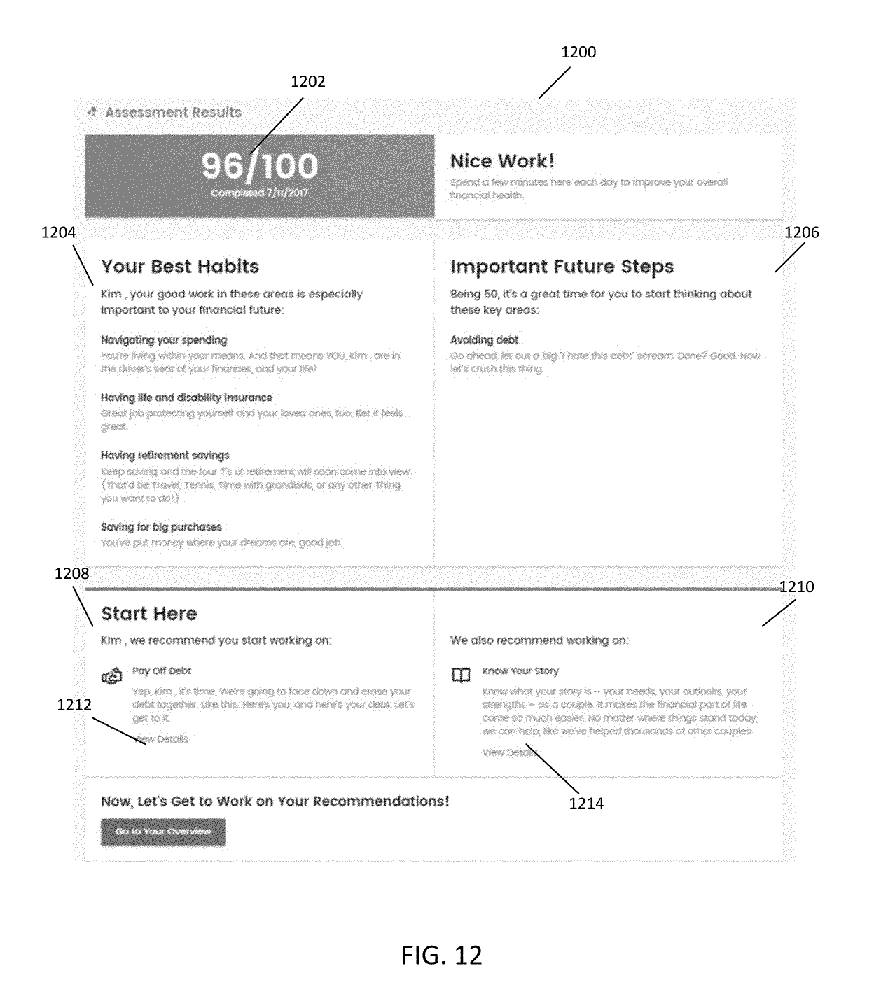

FIG. 12 provides an example of a display 1200 of the full results of the initial assessment. The display 500 once again includes the user score 1202. The display 1200 additionally includes a listing 1204 of the user's best habits, a listing 1206 of important future steps for the user, a panel 1208 with a recommendation as to which chapter the user should start with, and another panel 1210 recommending other chapters the user should work on; user-interactive links 1212, 1214 take the user into the respective chapter display page. Other display configurations are also possible.

Referring back to the flowchart of FIG. 9, upon user selection of one of the chapters, one or more of the recommended learning tools relevant to the chapter are displayed, S914. In certain examples, the user can also select chapters and/or learning tools that have not been recommended but are of interest. In certain examples, the learning tools displayed to the user are user-interactive, in which case the tracking module 208 can track any progress and/or completion of the learning tools, S916. In certain examples, the progress and/or completion of the various learning tools can result in the financial strength service 200 providing the user with various types of rewards and/or new learning tools to complete, S918. In certain examples, financial or non-financial products are offered to the user for purchase in association with building financial strength. In certain examples, banking services, such as those provided by a financial institution are offered to the user for use in building and/or tracking their financial strength.

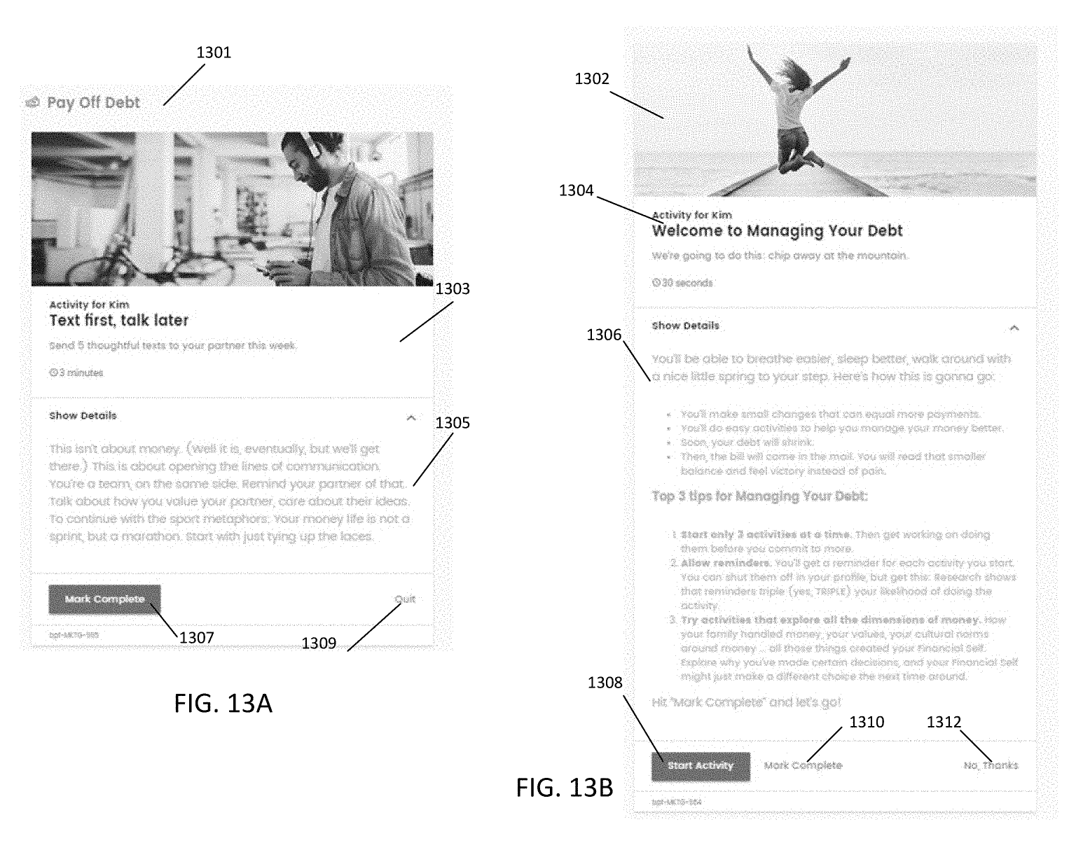

FIGS. 13A and 13B comprise first and second displays 1301, 1302, respectively, of learning tools within a Pay Off Your Debt chapter (described further below). Display 1301 illustrates a learning tool 1303, entitled “Text First, Talk Later,” for establishing communication with a partner. The display 1301 includes a detail panel 1305 regarding the learning tool 603 and provides the user with an interactive option to mark the learning tool 1303 complete, e.g. button 1307, or to quit the learning tool, e.g. quit link 1309. Display 1302 illustrates a learning tool 1304, entitled “Welcome to Managing Your Debt.” The display also includes a detail panel 1306 that further describes the learning tool 1304, an interactive option to start the learning tool, e.g. “start activity” button 1308, an interactive option to mark the learning tool complete, e.g. “mark complete” link 1310, and an option to decline to work on the learning tool, e.g. “no, thanks” link 1312. In certain examples, a plurality of learning tools are displayed on a single page while in others only a single learning tool is displayed on a page. Other display configurations suitable to the chapter and learning tool to be completed may also be used.

### II.A. Initial Assessment Module

The initial assessment module 202 gathers information about a registered user and uses that information to establish a user score that is currently representative of the user's love and money status. The questions posed to the user reflect consideration of the five dimensions (e.g. practical, spiritual, cultural, emotional and behavioral) of money. For example, the questions may indicate a likely tolerance or comfort with debt, your tendency toward preparedness for family emergencies and consideration of others, as well as how important money is to your happiness. Other factors may be possible as well. The data gathered by the initial assessment module 202 is stored in memory by the tracking module 208.

The data gathered by the initial assessment module 202 is preferably placed under one or more categories. In certain examples, the data gathered by the initial assessment module 202 is placed within the categories of (a) Basics; (b) Your Freedom; (c) Looking Out for Yourself and Your Family; (d) Money and Happiness; and (e) How you feel.

### II.A.i Basics

Within the category of Basics, the initial assessment module 202 queries the user as to:
(a) gender (male/female);
(b) the U.S. state in which you reside; and
(c) When it comes to love and money, which fits you best? (Single/Married/In a Committed Relationship and sharing finances).
   II.A.ii. Your Freedom

Within the category of Your Freedom, the initial assessment module 202 queries the user as to, which of the following items are true:
(a) I'm free from student loan debt.
(b) I'm free from credit card debt.
(c) I'm free from other big personal debt, such as medical debt or personal loans.
(d) I have a good credit score.
(e) I have a car that I own free and clear (no loan).
(f) I have a home I own free and clear (no mortgage or I'm renting).
   II.A.iii. Looking Out for Yourself and Your Family

Within the category of Looking Out for Yourself and Your Family, the initial assessment module 202 queries the user as to, which of the following items are true:
(a) I have at least $1,000 in emergency savings for when things go wrong.
(b) I have retirement savings.
(c) I have savings for big purchases, like vacations, a car, or a house.
(d) I have disability insurance* or I'm certain I don't need it.
(e) I have home/renter's insurance or I know I don't need it.
(f) I have auto insurance, or I don't need it because I don't own a car.
(g) I've got health insurance.
(h) I have life insurance, or I don't need it because no one depends on me.

Further, the user is queried as to whether they have children. If the user does have children, the user is additionally queried as to which of the following are true:
(a) I'm saving for my kids' college education.
(b) I haven't saved for my kids' college education.
(c) I know my kids don't need college money.
   II.A.iv. Money and Happiness

Within the category of Money and Happiness, the initial assessment module 202 queries the user as to how much they agree with the following questions (questions are rated on a 1 to 4 scale with 1=Disagree and 4=Agree):
(a) I have money goals and I plan to meet them.
(b) I feel confident about my overall financial knowledge, skills, and abilities.
(c) I make wise money decision that are free of negative emotions (such as fear, envy, pride, over-optimism, or stubbornness).
(d) My money decisions reflect my values.

Further, if the user has indicated that they are marred or in a committed relationship, the user is additionally queried as to how much they agree with the following question:
(e) My partner and I always work well together around finances.
   II.A.v. How You Feel

Within the category of How You Feel, the initial assessment module 202 queries the user as to which one of the following describes how they feel:
(a) I require financial assistance to get by.
(b) I am struggling to keep up with the day-to-day expenses.
(c) I am fairly stable, but just making ends meet.
(d) I am fairly secure, able to make ends meet and have some left over.
(e) I have more than I need for myself and my family.

The answers to each of the sets of questions can be used to generate an overall score visible to the user, as well as a subscore in each category that may or may not be visible to the user. The subscore for each category may influence the amount of time or prioritization for recommendations regarding financial decisions or learning tools to be presented to a user.

In certain examples, the initial assessment module 202 provides the user with the opportunity to write themselves a motivational message that can appear on subsequent user displays to provide the user with incentive. In certain examples, the user is requested to provide a response to the question “What will motivate you to get moving on your money goals?” Such response messages can be presented to the user at various times of day, or in response to specific detected financial events.

### II.B. Chapter Recommendation Module

The chapter recommendation module 204 generally operates to recommend certain love and money chapters to the user based on the results of their initial assessment. Once again, the recommendations take into consideration the five dimensions (e.g., practical, spiritual, cultural, emotional, and behavioral) of money, and can be based on the various scores and subscores assigned to a user. Any number of chapters can be presented to the user. In certain examples, the chapters include: (a) Know Your Story; (b) Navigate Spending; (c) Pay Off Debt; (d) Get Insurance; (e) Save for Retirement; (0 Save for Big Purchases; and (g) Practice Generosity.

In the example embodiments described herein, the specific chapters that are recommended may be recommended based on a user score or subscore derived from questions answered by that user. In other particular embodiments, the specific chapters that are recommended may be recommended based on a score, familial status, or determined financial activity of a family member of the user, such that family and financial planning are coordinated across users, despite each user having his/her own scoring. In certain examples, the chapter recommendation module 204 can recommend certain love and money chapters to the user in response to progress within or completion of various learning tools by the user; the progress or completion occurring subsequent to the initial assessment.

It is further noted that over time, as a user's financial situation changes, that user's scoring may change without requiring again performing the assessment. For example, the scoring may be automatically updated in response to changes in the user's status, for example reducing debt by paying off a loan, or purchasing a specific insurance, or reaching a savings threshold that was a set goal of the user. Accordingly, over time, different love and money chapters that are to be recommended may change according to the evolving score of the user. Furthermore, as a user's family members' scores also change, different chapters may be recommended similarly.

II.B.i. Chapter—Know Your Story

The Know Your Story chapter is recommended to the user in various scenarios, for example if the user has a low overall score or is a new user of the platform, or is below a predetermined age. In certain examples, the user can also access this chapter even without a recommendation. The Know Your Story chapter assists the user in learning about five dimensions of money and how they impact the user's financial success. More specifically, this chapter assists the user in understanding what they do and why, as it relates to their relationship with money. The chapter helps the user to integrate their financial picture with their emotional, behavioral, spiritual, and cultural background to create a future money story and a solid plan with the right learning tools to sustain behavior towards a life of contentment, confidence, and generosity; e.g. lives that reflect God's bigger story.

II.B.ii. Chapter—Navigate Spending

The Navigate Spending chapter is recommended to the user when the user (or a family member) is identified as spending a particular percentage of his/her income, has savings below a threshold, or in a variety of other scenarios. In certain examples, the user can also access this chapter even without a recommendation. The Navigate Spending chapter assists the user in managing money wisely and being prepared for the ups and downs of life. More specifically, this chapter assists the user in living beneath their means and managing their money more proactively. The chapter can help the user to establish a dedicated account just for emergency money, e.g. saving $1000 in this account as quickly as possible while assisting the user in working their way to saving three months of basic living expenses.

II.B.iii. Chapter—Pay Off Debt

The Pay Off Debt chapter is recommended to the user when a user score (or subscore) indicates that the user or a family member has substantial debt (e.g., debt over a threshold amount) or a goal of paying off a large purchase such as a house or car. In certain examples, the user can also access this chapter even without a recommendation. The Pay Off Debt chapter assists the user in learning the best ways to manage their debt to achieve financial freedom. More specifically, this chapter assists the user in being smart about debt by assisting them in paying down credit card debt first, then paying down auto loans, then paying down student loans and finally paying down mortgage loans.

II.B.iv. Chapter—Get Insurance

The Get Insurance chapter is recommended to the user when a user score (or subscore) determines that a user has a family including dependents, lacks insurance, or some combination thereof, or that this is important to another family member. In certain examples, the user can also access this chapter even without a recommendation. The Get Insurance chapter assists the user in achieving a feeling of confidence that their loved ones and their livelihood are protected. More specifically, this chapter assists the user in taking care of others and preparing for the unexpected. The chapter assists the user in obtaining basic life insurance and income protection to protect the user's family and themselves.

II.B.v. Chapter—Save for Retirement

The Save for Retirement chapter is recommended to the user when a user score or subscore indicates that the user has little long-term savings, or when a user indicates that such savings and/or early retirement is an important priority of that user and/or their family. In certain examples, the user can also access this chapter even without a recommendation. The Save for Retirement chapter assists the user in learning ways to save for their retirement as well as how much the user will need to build their retirement fund. More specifically, this chapter assists the user in setting themselves up to live fully by maxing out contributions to a 401(k) and/or establishing a basic IRA with regular contributions.

II.B.vi. Chapter—Save for Big Purchases

The Save for Big Purchases chapter is recommended to the user when the user or a family member identifies a particular purchase as a financial goal; a user score or subscore can also prompt the recommendation. In certain examples, the user can also access this chapter even without a recommendation. The Save for Big Purchases assists the user in preparing for big purchases such as a house, car, dream vacation, or child's education by finding ways to stash away extra cash. More specifically, this chapter assists the user in living with joy and confidence by knowing that what you are buying you can afford. The chapter assists the user in systematically putting away a percentage of every paycheck for big purchases or goals like buying a house, car, dream vacation, or a child's college education.

II.B.vii. Chapter—Practice Generosity

The Practice Generosity chapter is recommended to the user when, for example, the user or a family member has identified generosity as an important personality trait or one that the user wishes to develop, in combination with particular interests or areas of the user's life in which generosity can be demonstrated; a user score or subscore can also prompt the recommendation. In certain examples, the user can also access this chapter even without a recommendation. The Practice Generosity chapter assists the user in establishing a practice of active generosity to bring joy to their lives and the lives of others; it assists the user in experiencing abundance through gratitude. More specifically, this chapter assists the user in practicing generosity and cultivating abundance through a mindset of gratitude and contentment. Particular types of content in the chapter may include recommendations for ways to practice generosity both financially and non-financially, as well as recommendations for obtaining fulfillment or contentment from such behaviors.

### II.C. Learning Tool Recommendation Module

The learning tool recommendation module 204 operates to recommend certain learning tools on specific areas of focus or understanding that are associated with each chapter. Once again, the recommendations take into consideration the five dimensions (e.g., practical, spiritual, cultural, emotional, and behavioral) of money. In certain examples, the learning tools for the chapter are recommended in accordance with the user score or subscore determined by the initial assessment module 202. While in other examples, the learning tools are associated with the chapters regardless of the user score. Any number of learning tools for each chapter can be presented to the user. In certain examples, the learning tools include: (a) challenges/activities to be completed; (b) additional assessments and/or user-interactive tools; (c) learning/education; (d) community; (e) rewards and gamification; (f) transact; (g) history & accounts. It should be noted that in certain examples, one or more of the learning tools is enhanced by providing the user or their family member with reminders (e.g., e-mails, texts, messages within the service 200) to continue to work with their tools. Further, in certain examples, one or more of the learning tools is enhanced by providing motivational messages to the user in response to progress within or completion of a learning tool.

II.C.i. Learning Tool—Challenges/Activities to Be Completed

The Challenges/Activites to Be Completed learning tools are presented as activities aligned to a specific goal. The activities can be single step or multi-step challenges that are designed to result in sustainable behavior change. One example includes an activity to save a certain amount of money over a designated time period. Another example includes, cutting out a specific expense. Enhancement to the activities can be provided by utilizing notifications, within and outside the financial strength service 200, to prompt users to take the next action in their activities. Other examples include an activity to create a list of budget-friendly meals or to track spending. With these types of learning tools, the user is provided with fun, engaging and accessible steps to take within the financial strength service and outside the service. Further, the user achieves a progressive increase in their confidence level and perception of progress, and realizes behavior changes and sustained relationship health. Specific examples of activities are illustrated in FIGS. 13A and 13B. FIG. 13A is an activity prompting a user to communicate with their partner to let their partner know that they are valued and that their ideas are important. FIG. 13B is an activity recommending that the user start with three new activities to begin their process learning to manage debt.

In some examples, a user score can be calculated to determine the types of recurring challenges or activities that might be suggested to the user. For example, a very low score regarding tendency of a user to save money might trigger a suggestion to set a goal to save three months of expenses by setting reminders to set small amounts of money aside. A score by a family member indicating a high value placed on experiences may indicate to the user that he/she should save money for a vacation or other events. Other types of suggestions or activities could be triggered as well, and either automatically presented to the user or selectable by the user.

II.C.ii. Learning Tool—Additional Assessments and/or User-Interactive Tools

The Additional Assessments and/or User-Interactive Tools is a learning tool to ask the user questions, gather answers (data), evaluate that data and present responses. Programmed logic discerns which questions to ask next or when to invite the next assessment for the user. Assessments can be taken by an individual or an individual and family member. One example of an assessment is querying the user as to their contentment with life and contentment with things they have in their lives. An example of a user-interactive tool includes a credit card payoff calculator that can determine how long it will take a user to pay off their credit card debt, they amount of interest they will pay and/or a schedule for making payments. The ability to take in data from the user(s) results in personalized suggestions, feedback and results including the generation of additional learning tools to help the user understand, create scenarios and align their goals. The user is provided with increased self-awareness of their own situation in a fun, viscerally pleasing way with a focus on a holistic approach to their relationship and finances, current emotional approach, and behavior gaps.

II.C.iii. Learning Tool—Learning/Education

Learning/Education is a learning tool in the form of a catalog of learning modules that can be provided to the user based on the results of their assessments. The learning modules can be presented in various media formats including, for example, e-courses, videos and articles, and can be various topics including those related to relationships, communication, love and money (e.g. a video on understanding the differences between a Roth and a traditional IRA, or an article on positive communication). In certain examples, the media format of the learning module can be chosen by the user. In certain examples, the progress of the user through one or more learning modules is tracked to measure understanding and used alone, or in combination with the user score (subscore), to make further recommendations for additional learning modules and/or other learning tools. The learning modules provide the user with engaging and digestible content to increase their understanding at their own pace and at their own desired time and location. In certain examples, the learning modules are presented in chapter format where each chapter builds upon the previous chapters to deepen user understanding. In certain examples, the user can designate a favorite learning module to review multiple times or to share with others.

II.C.iv. Learning Tool—Community

Community is a learning tool that is directed to gathering users into communities around a suggested topic (e.g., saving for the future, organizing finances, etc.) and/or connecting users of the financial strength service 200 to other users of the service 200. In certain examples, the communities provide for threaded communication streams with posts and comments. Further, in certain examples, the communities are provided with moderators and participants. In certain examples, the communities are configured to integrate with broad social communities such as Facebook, LinkedIn, etc. Communities can provide the user with social proof and connections, as well as the ability to benefit from the wisdom of a crowd, e.g. learn and deepen understanding with others like them. Communities within the financial strength service 200 can provide the user with privacy and security, and can provide the user with focused conversations. In certain examples, communities within the financial strength service 200 enable the user to share content and experiences on social media sites that are outside the financial strength service 200.

In example embodiments the user score (or score of a family member) may indicate that the user may wish to be a member of a specific community within the platform. For example, specific faith-based communities or communities committed to charitable organizations may be available to the users having a high gratitude score indicating interest in giving back. Still other types of communities, such as those supporting specific life goals or age-group-based communities might be formed as well, and can be suggested to the user based at least in part on that user's score and other demographic information.

II.C.v. Learning Tool—Rewards and Gamification

The rewards and gamification learning tool is the ability to collect (actively and passively) data, calculate “value” and present “value” to the user (e.g., points). Rewards and gamification includes a catalog of games wherein the games are a means to track progress on a specific goal or understanding. The progress of the user of a game can be used to recommend other games or learning tools. Completion of a game provides a user with motivation and small value wins along their way to developing financial strength. Further, the games provide a user with a deeper level of engagement and understanding in their journey to financial strength success. The games also provide the user with a form of entertainment, which can act as a time filler, and can enhance learning.

II.C.vi. Learning Tool—Transact

The Transact learning tool provides an e-commerce capability to browse and purchase non-financial products, as well as an e-commerce capability to gather (passively and actively) data about a user(s) to provide personalized pricing, access, and quotes for financial products. Examples of products that can be offered by the financial strength service 200 include various insurance products (e.g. auto, home, health, life), banking services (e.g. checking accounts, savings accounts, loans, IRAs), and health counseling (e.g. how to quit smoking, how to deal with stress, doctor recommendations). Additional examples of products that can be offered by the financial strength service include products such as apparel, e-courses, and kits.

In certain examples, the Transact learning tool also provides the ability to collect from the user the information necessary to apply for a financial product as well as the ability to digitally sign for a financial product. In certain examples, the Transact learning tool interfaces without remote vendors of products and services providing access to the remote products and services within the financial strength service 200, or outside the financial strength service 200. In certain examples, the Transact learning tool maintains data from multiple vendors of products and services to assess against user data so as to make personalized recommendations to the user and/or provide comparisons of the products or services they could purchase. In certain examples, the Transact learning tool provides automatic underwriting based on a pre-established set of rules. With the Transact learning tool, the user is provided with a seamless and simple process to acquire the product and services that lead to relationship and financial strength. In certain examples, the Transact learning tool operates as a single stop shop, which is private and secure, for multiple financial and/or non-financial transactions.

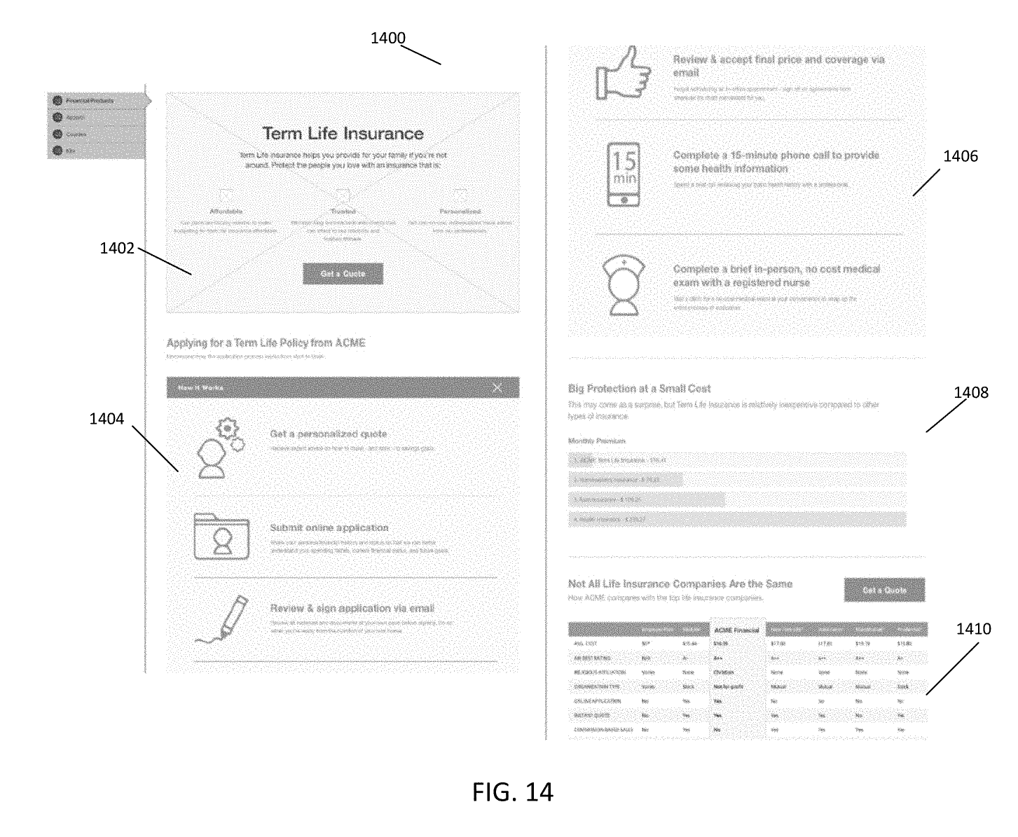

FIG. 14 illustrates an example of a user-interactive display 1400 that can be provided by the Transact learning tool. As shown, the display 1400 is focused on the product of life insurance and includes a panel 1402 offering a quote for term life insurance as well as a panel 1404 from a specific insurance company (e.g. ACME) that provides details about how the purchase of insurance can be made through the financial strength service 200 (e.g. get a personalized quote, submit an online application by sharing financial history and data stored within the financial strength service 200, review and sign application by e-mail). The display 1400 further includes a panel 1406 that provides useful insurance product information to the user (e.g. review & accept final price and coverage via e-mail) as well as selectable options to help the user complete the requirements for applying for life insurance (e.g. complete a 15-minute phone call to provide health information, complete a brief in-person no cost medical exam with a registered nurse). Another panel 1408 within the display 1400 illustrates the monthly premiums of term life insurance relative to the monthly premiums of other types of insurance while panel 1410 provides a comparison of companies that offer term life insurance.

In example embodiments, a particular score of the user or family member may result in a prompt or suggestion to consider a particular financial or non-financial product. For example, a health assessment or life insurance product may be offered to a user having a family but indicating that the user has little or no life insurance, but may have a high interest in protecting their family in the case of an adverse financial event.

II.C.vii. Learning Tool—History & Accounts

The History & Accounts learning tool provides the capability to present information to users about their purchased products or services (financial and non-financial). In certain examples, the information is provided from remote vendors (e.g. vendors of financial products) of the products and service via an interface with the financial strength service 200. In certain examples, the learning tool also provides self-service capability for the user to make changes to purchases products or services. This learning tool can also serve as the link to administrative systems that provides updates on programming and data within the financial strength service 200. With the History & Accounts learning tool, the user is provided with control of their products and services, with an integrated view of multiple products and services and with the convenience to make changes to their products/services at any time.

### II.D. Tracking Module

The tracking module 208 operates in conjunction with the other modules of the financial strength service 200 to store any user entered data, to store the user score determined by the initial assessment module 202 (or other subsequent assessment tools), and to store the recommendations as determined by the chapter recommendation module 204 and/or the learning tool recommendation module 206. The tracking module 208 can additionally serve as the repository for the catalogs, learning tool progress, and various other features associated with each chapter. The tracking module 208 can also perform any other tasks needed to execute the functions of the financial strength service 200 that are not performed by the other modules.

### II.E. Display Module

The display module 210 operates in conjunction with the other modules of the financial strength service 200 to generate the various graphical user interfaces that are necessary and/or suitable to execute and achieve the various functions and/or operations described above.

### III. Computing Device

FIG. 15 is a block diagram illustrating physical components of an example computing device with which aspects of the present disclosure may be practiced. The computing device 1500 can include at least one processing unit (processor) 1502 and a system memory 1504. The system memory 1504 may comprise, but is not limited to, volatile (e.g. random access memory (RAM)), non-volatile (e.g. read-only memory (ROM)), flash memory, or any combination thereof. System memory 1504 may include operating system 1506, one or more program instructions 15015, and may include sufficient computer-executable instructions for the financial strength service 200, which when executed, perform functionalities as described herein. Operating system 1506, for example, may be suitable for controlling the operation of computing device 1500. Furthermore, aspects may be practiced in conjunction with a graphics library, other operating systems, or any other application program and is not limited to any particular application or system. This basic configuration is illustrated by those components within a dashed line 1510. Computing device 1500 may also include one or more input device(s) 1512 (keyboard, mouse, pen, touch input device, etc.) and one or more output device(s) 1514 (e.g., display, speakers, a printer, etc.).

The computing device 1500 may also include additional data storage devices (removable or non-removable) such as, for example, magnetic disks, optical disks, or tape. Such additional storage is illustrated by a removable storage 1516 and a non-removable storage 15115. Computing device 1500 may also contain a communication connection 1520 that may allow computing device 1500 to communicate with other computing devices 1522, such as over a network in a distributed computing environment, for example, an intranet or the Internet. Communication connection 1520 is one example of a communication medium, via which computer-readable transmission media (i.e., signals) may be propagated.

Programming modules, may include routines, programs, components, data structures, and other types of structures that may perform particular tasks or that may implement particular abstract data types. Moreover, aspects may be practiced with other computer system configurations, including hand-held devices, multiprocessor systems, microprocessor-based or programmable user electronics, minicomputers, mainframe computers, and the like. Aspects may also be practiced in distributed computing environments where tasks are performed by remote processing devices that are linked through a communications network. In a distributed computing environment, programming modules may be located in both local and remote memory storage devices.

Furthermore, aspects may be practiced in an electrical circuit comprising discrete electronic elements, packaged or integrated electronic chips containing logic gates, a circuit using a microprocessor, or on a single chip containing electronic elements or microprocessors (e.g., a system-on-a-chip (SoC)). Aspects may also be practiced using other technologies capable of performing logical operations such as, for example, AND, OR, and NOT, including, but not limited to, mechanical, optical, fluidic, and quantum technologies. In addition, aspects may be practiced within a general purpose computer or in any other circuits or systems.

Aspects may be implemented as a computer process (method), a computing system, or as an article of manufacture, such as a computer program product or computer-readable storage medium. The computer program product may be computer storage medium readable by a computer system and encoding a computer program of instructions for executing a computer process. Accordingly, hardware or software (including firmware, resident software, micro-code, etc.) may provide aspects discussed herein. Aspects may take the form of a computer program product on a computer-usable or computer-readable storage medium having computer-usable or computer-readable program code embodied in the medium for use by, or in connection with, an instruction execution system.

Although aspects have been described as being associated with data stored in memory and other storage mediums, data can also be stored on or read from other types of computer-readable media, such as secondary storage devices, like hard disks, floppy disks, or a CD-ROM, or other forms of RAM or ROM. The term computer-readable storage medium refers only to devices and articles of manufacture that store data or computer-executable instructions readable by a computing device. The term computer-readable storage media do not include computer-readable transmission media.

Aspects of the present invention may be used in various distributed computing environments where tasks are performed by remote processing devices that are linked through a communications network.

Aspects of the invention may be implemented via local and remote computing and data storage systems. Such memory storage and processing units may be implemented in a computing device. Any suitable combination of hardware, software, or firmware may be used to implement the memory storage and processing unit. For example, the memory storage and processing unit may be implemented with computing device 1500 or any other computing devices 1522, in combination with computing device 1500, wherein functionality may be brought together over a network in a distributed computing environment, for example, an intranet or the Internet, to perform the functions as described herein. The systems, devices, and processors described herein are provided as examples; however, other systems, devices, and processors may comprise the aforementioned memory storage and processing unit, consistent with the described aspects.

The description and illustration of one or more aspects provided in this application are intended to provide a thorough and complete disclosure the full scope of the subject matter to those skilled in the art and are not intended to limit or restrict the scope of the invention as claimed in any way. The aspects, examples, and details provided in this application are considered sufficient to convey possession and enable those skilled in the art to practice the best mode of the claimed invention. Descriptions of structures, resources, operations, and acts considered well-known to those skilled in the art may be brief or omitted to avoid obscuring lesser known or unique aspects of the subject matter of this application. The claimed invention should not be construed as being limited to any embodiment, aspects, example, or detail provided in this application unless expressly stated herein. Regardless of whether shown or described collectively or separately, the various features (both structural and methodological) are intended to be selectively included or omitted to produce an embodiment with a particular set of features. Further, any or all of the functions and acts shown or described may be performed in any order or concurrently. Having been provided with the description and illustration of the present application, one skilled in the art may envision variations, modifications, and alternate embodiments falling within the spirit of the broader aspects of the general inventive concept provided in this application that do not depart from the broader scope of the present disclosure.

1. A financial strength system comprising:
a processor configured to execute instructions stored in memory, the instructions causing the processor to:
(a) obtain the results of a user-assessment from a user and a family member of the user, the results including data representative of practical, spiritual, cultural, emotional and behavioral relationship behaviors relating to money; and
(b) based on the results from both the user and the family member and a plurality of rules applied to the results, recommend a learning tool that will assist in improving one or more of the user's practical, spiritual, cultural, emotional and behavioral relationship with money.

2. The financial strength system of claim 1, wherein the recommended learning tool comprises a recommendation to purchase insurance.

3. The financial strength system of claim 2, wherein the recommendation is to purchase insurance from a specific insurance company.

4. The financial strength system of claim 3, wherein the specific insurance company is selected from a plurality of insurance companies based on both data specific to each of the plurality of insurance companies and the results from both the user and the family.

5. The financial strength system of claim 2, wherein an application for a purchase of the recommended insurance is transacted through the financial strength system.

6. The financial strength system of claim 2, wherein a purchase of the recommended insurance by the user is transacted through the financial strength system.

7. A system comprising:
a computing platform accessible by a plurality of users via client systems communicatively connected thereto, the computing platform hosting a financial strength guidance application, the financial strength guidance application comprising:
at least one user segment layer constructed for use by a category of users;
a recommendation engine layer configured to iteratively generate recommendations for actions to be taken by a user, the recommendations displayable in the user segment layer;
an extensible capability hosting layer comprising a plurality of user engagement tools, each of the plurality of user engagement tools exposing an Application Programming Interface (API) to the recommendation engine layer, the plurality of user engagement tools including at least a financial recommendation tool, a challenges tool, an incentives tool, a dashboard tool, and a community tool;
wherein the recommendation engine layer is configured to, based on a determined assessment of a user interacting with the system via the at least one user segment layer, call one or more of the user engagement tools via a corresponding API to engage the user with the one or more user engagement tools.

8. The system of claim 7, wherein the plurality of user engagement tools includes a plurality of modules selected from the group consisting of: a user registration module, an assessment module, a calculator module, a recommendation module, a challenges module, a scoring module, and an education module.

9. The system of claim 7, wherein the recommendation engine layer generates recommendations based at least in part on information received from the user and information inferred regarding the user from user interaction with the financial strength guidance application

10. The system of claim 9, wherein the recommendation engine layer generates recommendations further based on information about the user and the user's family obtained from one or more third party services.

11. The system of claim 7, wherein the user segment layer includes a plurality of user segment profiles, each user segment profile configured to generate one or more user interfaces to the financial strength guidance application customized to a different group of users.

12. A computer-implemented method of interacting with a user to provide a financial strength guidance, the method comprising:
obtaining, at a financial strength service, the results of a user-assessment from a user and a family member of the user, the results including data representative of practical, spiritual, cultural, emotional and behavioral relationship behaviors relating to money; and
based on the results from both the user and the family member and a plurality of rules applied to the results, iteratively recommending one or more learning tools that will assist in improving one or more of the user's practical, spiritual, cultural, emotional and behavioral relationship with money; and
in response to selection of a learning tool, calling one or more of a plurality of user engagement tools, each of the plurality of user engagement tools exposing an Application Programming Interface (API) via which the corresponding user engagement tool is extensibly integrated into the financial strength service.

13. The method of claim 12, further comprising presenting to the user a user interface generated in accordance with a user experience profile associated with the user.

14. The method of claim 13, wherein recommending the learning tool is based at least in part on the user experience profile associated with the user.
